(19) United States
(12) Patent Application Publication
(10) Pub. No.: US 2022/0376410 A1
(43) Pub. Date: Nov. 24, 2022

(54) ELECTRICAL HARNESS ASSEMBLY FOR AN AGRICULTURAL IMPLEMENT

(71) Applicant: CNH Industrial America LLC, New Holland, PA (US)

(72) Inventors: Jacob Allan Weis, Bolingbrook, IL (US); Ryan Douglas Collins, La Grange Park, IL (US)

(73) Assignee: CNH Industrial America LLC

(21) Appl. No.: 17/328,500

(22) Filed: May 24, 2021

(51) Int. Cl. H01R 11/01; B60R 16/02

(52) U.S. Cl. CPC H01R 11/01; B60R 16/0207; A01C 7/105

(57) ABSTRACT

An electrical harness assembly for an agricultural implement includes multiple harness segments coupled to one another. Each harness segment includes a first connector, a second connector, and a third connector. In addition, the second connector of each harness segment is configured to directly couple to the first connector of a subsequent harness segment, the third connector of each harness segment is configured to couple to a respective row unit component, and each harness segment does not include a harness controller.

### BACKGROUND

The present disclosure relates generally to an electrical harness assembly for an agricultural implement.

Generally, planting implements (e.g., planters) are towed behind a tractor or other work vehicle via a mounting bracket secured to a rigid frame of the implement. Planting implements typically include multiple row units distributed across a width of the implement. Each row unit is configured to deposit seeds at a desired depth beneath the soil surface of a field, thereby establishing rows of planted seeds. For example, each row unit typically includes a ground engaging tool or opener that forms a seeding path (e.g., trench) for seed deposition into the soil. An agricultural product conveying system (e.g., seed tube or powered agricultural product conveyor) is configured to deposit seeds and/or other agricultural products (e.g., fertilizer) into the trench. The opener/agricultural product conveying system is followed by closing discs that move displaced soil back into the trench and/or a packer wheel that packs the soil on top of the deposited seeds/other agricultural products.

Each row unit of the planting implement may include an agricultural product meter (e.g., vacuum agricultural product meter, etc.) configured to control a flow rate of the agricultural product (e.g., seed/other agricultural product) to the agricultural product conveying system, thereby establishing a desired distribution of the agricultural product throughout the field. In addition, each row unit may include an agricultural product sensor configured to monitor flow of the agricultural product (e.g., seed, fertilizer, etc.) through the agricultural product conveying system. Furthermore, each row unit may include other and/or additional sensors (e.g., soil monitoring sensor(s), penetration depth sensor(s), downforce sensor(s), etc.) and/or one or more actuators (e.g., downforce actuator(s), penetration depth actuator(s), etc.).

The agricultural product meter, the agricultural product sensor, any other/additional sensor(s), any actuator(s), or a combination thereof, of each row unit may be communicatively coupled to a controller of the planting implement via an electrical harness. The electrical harness may include a backbone and row unit conductor assemblies extending from the backbone. One or more connectors may be coupled to each row unit conductor assembly to facilitate coupling certain component(s) of a respective row unit (e.g., row unit controller, sensor(s), actuator(s), agricultural product meter, etc.) to the electrical harness. Due to variations in the spacing between the row units on the planting implement, variations in the number of row units on the planting implement, and variations in the arrangement of the row units on the planting implement (e.g., left wing, right wing, central portion, etc.), a large number of electrical harnesses may be designed and manufactured to accommodate various planting implement configurations. Unfortunately, the expense associated with designing and manufacturing a large variety of electrical harnesses for the planting implements may significantly increase the cost of the planting implements.

### BRIEF DESCRIPTION

In certain embodiments, an electrical harness assembly for an agricultural implement includes multiple harness segments coupled to one another. Each harness segment includes a first connector, a second connector, and a third connector. In addition, the second connector of each harness segment is configured to directly couple to the first connector of a subsequent harness segment, the third connector of each harness segment is configured to couple to a respective row unit component, and each harness segment does not include a harness controller.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an agricultural implement having multiple row units distributed across a width of the agricultural implement;

FIG. 2 is a side view of an embodiment of a row unit that may be employed on the agricultural implement of FIG. 1;

FIG. 3 is a top view of an embodiment of an electrical harness assembly that may be coupled to the row units of the agricultural implement of FIG. 1;

FIG. 4 is a schematic view of an embodiment of a harness segment that may be employed within the electrical harness assembly of FIG. 3;

FIG. 5 is a schematic view of another embodiment of a harness segment that may be employed within the electrical harness assembly of FIG. 3; and

FIG. 6 is a flow diagram of an embodiment of a method of forming an electrical harness assembly for an agricultural implement.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

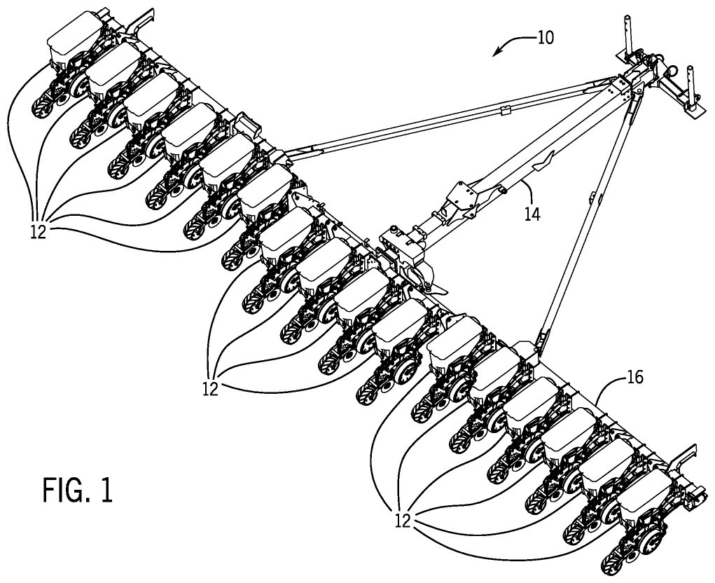

FIG. 1 is a perspective view of an embodiment of an agricultural implement 10 (e.g., planting implement) having multiple row units 12 distributed across a width of the agricultural implement 10. The agricultural implement 10 is configured to be towed through a field behind a work vehicle, such as a tractor. As illustrated, the agricultural implement 10 includes a tongue assembly 14, which includes a hitch configured to couple the agricultural implement 10 to an appropriate tractor hitch (e.g., via a ball, clevis, or other coupling). The tongue assembly 14 is coupled to a tool bar 16 which supports multiple row units 12. Each row unit 12 may include one or more opener discs configured to form a seed path (e.g., trench) within soil of a field. The row unit 12 may also include an agricultural product conveying system (e.g., seed tube or powered agricultural product conveyer) configured to deposit seeds and/or other agricultural product(s) (e.g., fertilizer) into the seed path/trench. In addition, the row unit 12 may include closing disc(s) and/or a packer wheel positioned behind the agricultural product conveying system. The closing disc(s) are configured to move displaced soil back into the seed path/trench, and the packer wheel is configured to pack soil on top of the deposited seeds/other agricultural product(s).

As discussed in detail below, each row unit 12 of the agricultural implement 10 includes an agricultural product meter (e.g., vacuum agricultural product meter) and a storage compartment (e.g., hopper, mini-hopper, etc.). In certain embodiments, the storage compartment (e.g., hopper) stores a sufficient amount of agricultural product to complete a desired planting operation. Furthermore, in certain embodiments, the storage compartment (e.g., mini-hopper) is configured to receive agricultural product (e.g., continuously, periodically, on-demand, etc.) from a central storage compartment of the agricultural implement during the planting operation. The agricultural product meter is configured to control a flow rate of the agricultural product (e.g., seed, fertilizer, other agricultural product, etc.) to the agricultural product conveying system, thereby controlling the flow rate of the agricultural product into the trench. As a result, a desired distribution of the agricultural product throughout the field (e.g., a desired seed spacing along a respective seed row) may be established.

Furthermore, in certain embodiments, each row unit of the agricultural implement may include an agricultural product sensor configured to monitor flow of the agricultural product (e.g., seed, fertilizer, other agricultural product, etc.) through the agricultural product conveying system. For example, in certain embodiments, an optical sensor may be coupled to a seed tube. In such embodiments, the optical sensor may detect each particle (e.g., seed, etc.) as the particle moves downwardly through the seed tube, thereby facilitating determination of flow of the agricultural product into the trench.

The agricultural product meter and/or the agricultural product sensor of each row unit is communicatively coupled to a controller of the agricultural implement and/or electrically coupled to a power source of the agricultural implement by an electrical harness assembly. In certain embodiments, the electrical harness assembly includes multiple harness segments coupled to one another. Each harness segment includes a first connector, a second connector, and a third connector. The second connector of each harness segment is configured to directly couple to the first connector of a subsequent harness segment, thereby establishing a chain of harness segments that forms the electrical harness assembly. In addition, the third connector of each harness segment is configured to couple to at least one respective row unit component (e.g., at least one component of a respective row unit), such as the agricultural product meter, the agricultural product sensor, a row unit controller, other suitable sensor(s) of the respective row unit, one or more actuators of the respective row unit, or a combination thereof. Furthermore, each harness segment of the electrical harness assembly does not include a harness controller. Accordingly, signals/electrical power may pass through the electrical harness assembly between a controller/electrical power source of the agricultural implement and the row unit components. Because the electrical harness assembly is formed by coupling multiple harness segments to one another, the costs associated with designing and manufacturing/forming electrical harnesses for a variety of implement configurations (e.g., number of row units, spacing between row units, arrangement of row units, etc.) may be substantially reduced, as compared to designing and manufacturing a unique electrical harness for each implement configuration.

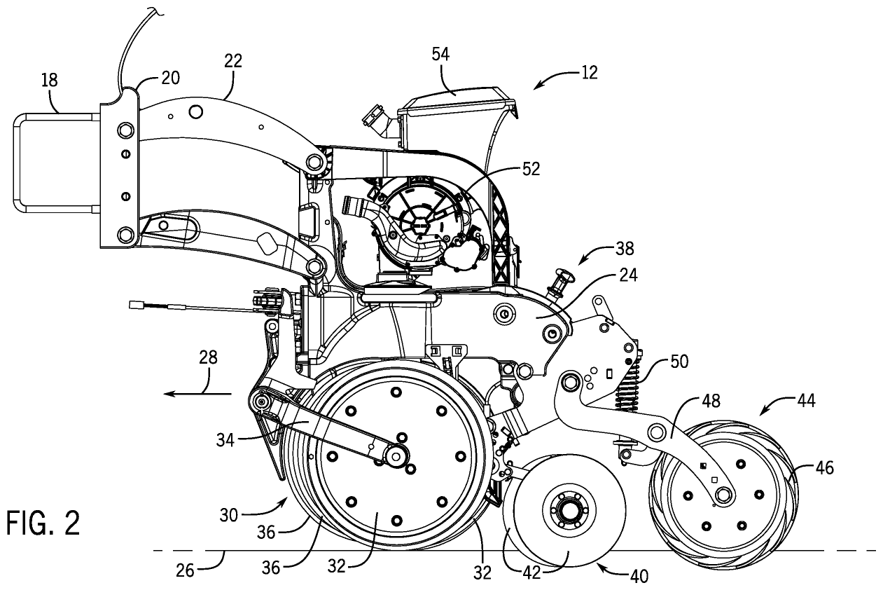

FIG. 2 is a side view of an embodiment of a row unit 12 (e.g., agricultural row unit) that may be employed on the agricultural implement of FIG. 1. The row unit 12 includes a mount 18 configured to secure the row unit 12 to the tool bar of the agricultural implement. In the illustrated embodiment, the mount 18 includes a u-bolt that secures a bracket 20 of the row unit 12 to the tool bar. However, in other embodiments, the mount may include another suitable device that couples the row unit to the tool bar. A linkage assembly 22 extends from the bracket 20 to a frame 24 of the row unit 12. The linkage assembly 22 is configured to enable vertical movement of the frame 24 relative to the tool bar in response to variations in a soil surface 26. In certain embodiments, a down pressure system (e.g., including a hydraulic actuator, a pneumatic actuator, etc.) may be coupled to the linkage assembly 22 and configured to urge the frame 24 toward the soil surface 26. While the illustrated linkage assembly 22 is a parallel linkage assembly (e.g., a four-bar linkage assembly), in other embodiments, another suitable linkage assembly may extend between the bracket and the frame.

The row unit 12 is configured to deposit seeds and/or other agricultural product(s) at a desired depth beneath the soil surface 26 as the row unit 12 traverses a field along a direction of travel 28. The row unit 12 includes an opener assembly 30 that forms a trench in the soil for seed/other agricultural product deposition into the soil. In the illustrated embodiment, the opener assembly 30 includes gauge wheels 32, arms 34 that pivotally couple the gauge wheels 32 to the frame 24, and opener discs 36. The opener discs 36 are configured to excavate a trench into the soil, and the gauge wheels 32 are configured to control a penetration depth of the opener discs 36 into the soil. In the illustrated embodiment, the row unit 12 includes a depth control system 38 configured to control the vertical position of the gauge wheels 32 (e.g., by blocking rotation of the arms in the upward direction beyond a selected orientation), thereby controlling the penetration depth of the opener discs 36 into the soil. In certain embodiments, the depth control system 38 may include an actuator configured to control the vertical position of the gauge wheels 32. While the opener assembly 30 includes opener discs 36 in the illustrated embodiment, in other embodiments, the opener assembly may include any other suitable opener(s) (e.g., knife blade opener(s), coulter(s), etc.) configured to form the trench in the soil.

The row unit 12 also includes an agricultural product conveying system (e.g., seed tube or powered agricultural product conveyor) configured to deposit seeds and/or other agricultural product(s) (e.g., fertilizer) into the trench. The opener assembly 30 and the agricultural product conveying system are followed by a closing assembly 40 that moves displaced soil back into the trench. In the illustrated embodiment, the closing assembly 40 includes two closing discs 42. However, in other embodiments, the closing assembly may include other closing device(s) (e.g., a single closing disc, etc.). In addition, in certain embodiments, the closing assembly may be omitted. In the illustrated embodiment, the closing assembly 40 is followed by a packing assembly 44 configured to pack soil on top of the deposited seeds and/or other agricultural product(s). The packing assembly 44 includes a packer wheel 46, an arm 48 that pivotally couples the packer wheel 46 to the frame 24, and a biasing member 50 configured to urge the packer wheel 46 toward the soil surface 26, thereby enabling the packer wheel to pack soil on top of the deposited seeds and/or other agricultural product(s). While the illustrated biasing member 50 includes a spring, in other embodiments, the biasing member may include other suitable biasing device(s) (e.g., alone or in combination with the spring), such as another spring, a hydraulic cylinder, a pneumatic cylinder, other suitable biasing device(s), or a combination thereof. Furthermore, in certain embodiments, the packing assembly may be omitted.

The row unit 12 includes an agricultural product meter 52 configured to receive agricultural product (e.g., seeds) from a storage compartment 54. In the illustrated embodiment, the storage compartment 54 includes a mini-hopper configured to receive agricultural product (e.g., continuously, periodically, on-demand, etc.) from a central storage compartment of the agricultural implement during planting operations. However, in other embodiments, the storage compartment may include a hopper configured to store a sufficient amount of agricultural product to complete a desired planting operation, or any other suitable container or combination of containers. Furthermore, in the illustrated embodiment, the agricultural product meter 52 includes a vacuum seed meter, which includes a disc having multiple openings. An air pressure differential between opposite sides of the disc induces the agricultural product (e.g., seeds) to be captured within the openings. As the disc rotates, the agricultural product is conveyed toward the agricultural product conveying system. When the agricultural product (e.g., seed) is aligned with an inlet to the agricultural product conveying system, the air pressure on each side of the disc is substantially equalized (e.g., at the end of a vacuum passage), thereby enabling the agricultural product (e.g., seed) to enter the agricultural product conveying system (e.g., seed tube or powered agricultural product conveyor). The agricultural product conveying system then directs the agricultural product to the trench. While the agricultural product meter includes a vacuum seed meter in the illustrated embodiment, in other embodiments, other suitable seed/agricultural product meters may be utilized. As used herein, “vacuum” refers to an air pressure that is less than the ambient atmospheric air pressure, and not necessarily 0 pa.

In certain embodiments, the row unit may include an agricultural product sensor configured to monitor flow of the agricultural product (e.g., seed, fertilizer, other agricultural product, etc.) through the agricultural product conveying system. For example, in certain embodiments, an optical sensor may be coupled to a seed tube. In such embodiments, the optical sensor may detect each particle (e.g., seed, etc.) as the particle moves downwardly through the seed tube, thereby facilitating determination of flow of the agricultural product into the trench.

Furthermore, in certain embodiments, the row unit may include one or more other sensors configured to monitor operation of the row unit and/or one or more properties of the soil. For example, the row unit may include a soil sensor configured to monitor one or more properties of the soil (e.g., soil moisture content, soil nutrient content, soil firmness, etc.). In certain embodiments, the soil sensor may include an electrical resistivity sensor configured to monitor a moisture content of the soil, an optical sensor configured to monitor a nutrient content of the soil, a penetrometer configured to monitor a firmness of the soil, other suitable type(s) of soil sensor(s), or a combination thereof. Furthermore, in certain embodiments, the row unit may include a soil profile sensor configured to monitor a profile of the soil, a penetration depth sensor configured to monitor a depth of the trench within the soil, other suitable sensor(s), or a combination thereof.

In addition, the row unit may include a row unit controller configured to control operation of certain actuator(s) of the row unit and/or to determine certain parameters based on feedback from one or more sensors. For example, in certain embodiments, the row unit controller may be communicatively coupled to the agricultural product meter, to an actuator of the depth control system, to an actuator of the down pressure system, to the agricultural product sensor, to other suitable sensor(s) (e.g., soil sensor(s), penetration depth sensor(s), etc.), to other suitable actuator(s) (e.g., closing disc downforce actuator(s), packer wheel downforce actuator(s), etc.), or a combination thereof. In certain embodiments, the row unit controller may be omitted (e.g., and the row unit actuator(s)/sensor(s) may be communicatively coupled to an agricultural implement controller remote from the row unit).

In certain embodiments, the agricultural product meter, the agricultural product sensor, the actuator of the depth control system, the actuator of the down pressure system, other suitable sensor(s) (e.g., soil sensor(s), penetration depth sensor(s), etc.), other suitable actuator(s) (e.g., closing disc downforce actuator(s), packer wheel downforce actuator(s), etc.), or a combination thereof, of each row unit is communicatively coupled to a controller of the agricultural implement (e.g., via a respective row unit controller) and/or electrically coupled to a power source of the agricultural implement by an electrical harness assembly. In certain embodiments, the electrical harness assembly includes multiple harness segments coupled to one another. Each harness segment includes a first connector, a second connector, and a third connector. The second connector of each harness segment is configured to directly couple to the first connector of a subsequent harness segment, thereby establishing a chain of harness segments that forms the electrical harness assembly. In addition, the third connector of each harness segment is configured to couple to at least one respective row unit component (e.g., the agricultural product meter, the agricultural product sensor, the row unit controller, other suitable sensor(s) of the row unit, one or more actuators of the row unit, or a combination thereof). Furthermore, each harness segment of the electrical harness assembly does not include a harness controller. Accordingly, signals/electrical power may pass through the electrical harness assembly between a controller/electrical power source of the agricultural implement and the row units components. Because the electrical harness assembly is formed by coupling multiple harness segments to one another, the costs associated with designing and manufacturing/forming electrical harnesses for a variety of implement configurations (e.g., number of row units, spacing between row units, arrangement of row units, etc.) may be substantially reduced, as compared to designing and manufacturing a unique electrical harness for each implement configuration.

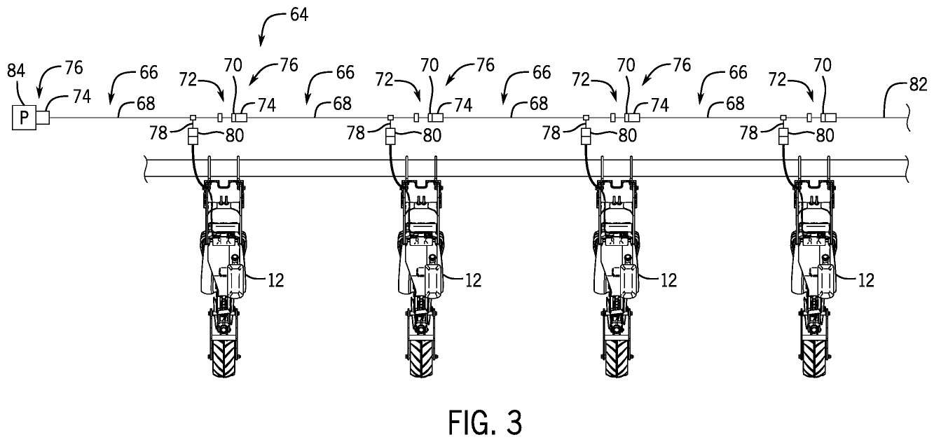

FIG. 3 is a top view of an embodiment of an electrical harness assembly 64 that may be coupled to the row units 12 of the agricultural implement of FIG. 1. In the illustrated embodiment, the electrical harness assembly 64 includes multiple harness segments 66 coupled to one another. Each harness segment 66 includes a first conductor assembly 68 and a first connector 70 coupled to a first end 72 of the first conductor assembly 68. In addition, each harness segment 66 includes a second connector 74 coupled to a second end 76 of the first conductor assembly 68. The second connector 74 of each harness segment 66 is configured to directly couple to the first connector 70 of a subsequent harness segment 66. Furthermore, each harness segment 66 includes a second conductor assembly 78 coupled to the first conductor assembly 68 between the first connector 70 and the second connector 74 (e.g., inclusive of the first connector 70 and the second connector 74). Each harness segment 66 also includes a third connector 80 coupled to the second conductor assembly 78, in which the third connector 80 is configured to couple to at least one respective row unit component (e.g., corresponding connector(s) of the respective row unit component(s)). While each harness segment 66 has a single conductor assembly 78 coupled to the first conductor assembly 68 in the illustrated embodiment, in other embodiments, at least one harness segment may include multiple conductor assemblies coupled to the first conductor assembly between the first and second connectors, as discussed in detail below.

As previously discussed, the respective row unit component(s) coupled to each third connector 80 may include the agricultural product meter of the respective row unit, the agricultural product sensor of the respective row unit, the row unit controller of the respective row unit, other suitable sensor(s) of the respective row unit, one or more actuators of the respective row unit, or a combination thereof. For example, in certain embodiments, at least one third connector 80 (e.g., each third connector of the electrical harness assembly) may be configured to coupled to a single respective component. Furthermore, in certain embodiments, at least one third connector 80 (e.g., each third connector of the electrical harness assembly) may be configured to couple to multiple respective components (e.g., 2, 3, 4, 5, 6, or more).

In certain embodiments, the electrical harness assembly 64 is configured to facilitate passage of one or more communication signals between the implement controller and the components coupled to the third connectors 60. Additionally or alternatively, the electrical harness assembly 64 is configured to facilitate passage of electrical power from a power source to the components coupled to the third connectors 60. In the illustrated embodiment, the first connector 70 of a first harness segment 66 is coupled to a conductor assembly 82 that extends to the implement controller and/or to the power source. In certain embodiments, the agricultural implement may include multiple electrical harness assemblies, and each electrical harness assembly may be configured to facilitate passage of one or more communication signals and/or electrical power. For example, in certain embodiments, the agricultural implement may include one or more electrical harness assemblies configured to facilitate passage of one or more communications signals and/or one or more electrical harness assemblies configured to facilitate passage of electrical power. Additionally or alternatively, the agricultural implement may include at least one electrical harness assembly configured to facilitate passage of one or more communication signals and electrical power.

In the illustrated embodiment, the electrical harness assembly 64 includes a plug 84 coupled to the second connector 74 of the last harness segment 66 of the electrical harness assembly 64. The plug 84 is configured to substantially seal the second connector 74 to substantially block dirt and/or debris from entering an interior of the second connector 74 of the last harness segment 66. Furthermore, in certain embodiments (e.g., embodiments in which the electrical harness assembly is configured to facilitate passage of one or more communication signals), the plug 84 may include circuitry configured to indicate to the implement controller that no additional row unit components are coupled to the electrical harness assembly (e.g., termination of a chain of row unit components). While the electrical harness assembly 64 includes the plug 84 in the illustrated embodiment, in other embodiments, the plug may be omitted.

A length of the first conductor assembly 68 of at least one harness segment 66 (e.g., each harness segment 66 of the electrical harness assembly 64) may be selected based on a spacing between the row units 12. For example, in certain agricultural implement configurations, the row units may be spaced apart from one another to establish 20-inch or 22-inch row spacing. For such implement configurations, the length of the first conductor assembly 68 of each harness segment 66 may be selected such that the third connector 80 of each harness segment 66 substantially aligns with corresponding connector(s) of the respective row unit component(s). Furthermore, in certain agricultural implement configurations, the row units may be spaced apart from one another to establish 36-inch or 40-inch row spacing. For such implement configurations, the length of the first conductor assembly 68 of each harness segment 66 may be selected such that the third connector 80 of each harness segment 66 substantially aligns with corresponding connector(s) of the respective row unit component(s). For example, a first set of harness segments may be formed for agricultural implements having 20-inch or 22-inch row spacing, and a second set of harness segments may be formed for agricultural implements having 36-inch or 40-inch row spacing. The electrical harness assembly 64 may be formed by coupling the harness segments of a selected set to one another to form an electrical harness assembly suitable for the row unit spacing of the agricultural implement. In certain embodiments, the length of the first conductor assembly of each harness segment of the first set may be selected to accommodate 22-inch row spacing, and the first conductor assemblies may be more slack/loose when used with agricultural implements having 20-inch row spacing. In addition, the length of the first conductor assembly of each harness segment of the second set may be selected to accommodate 40-inch row spacing, and the first conductor assemblies may be more slack/loose when used with agricultural implements having 36-inch row spacing. While harness segments configured for 20/22-inch row spacing and 36/40-inch row spacing are disclosed above, the length of the first conductor assembly 68 of at least one harness segment 66 (e.g., each harness segment 66 of the electrical harness assembly 64) may be selected based on any suitable spacing between the row units 12.

Furthermore, the electrical harness assembly may be formed by selecting a suitable number of harness segments based on the number of row units coupled to the agricultural implement/portion of the agricultural implement. For example, the number of harness segments may be selected to match the number of row units. In certain agricultural implements, the row units may be arranged along a single toolbar. In such embodiments, a single electrical harness assembly may be formed based on the number of row units coupled to the single toolbar and the spacing between the row units. Furthermore, certain agricultural implements may include multiple toolbars, and row units may be arranged along each toolbar. For example, in certain embodiments, the agricultural implement may include a central toolbar, a left wing toolbar pivotally coupled to the central toolbar, and a right wing toolbar pivotally coupled to the central toolbar. In such embodiments, the agricultural implement may include a first electrical harness assembly for the row units coupled to the central toolbar, a second electrical harness assembly for the row units coupled to the left wing toolbar, and a third electrical harness assembly for the row units coupled to the right wing toolbar. Each electrical harness assembly may be formed based on the number of row units coupled to the respective toolbar and the spacing between row units. For example, the number of row units coupled to the left wing toolbar may be different than the number of row units coupled to the central toolbar. Because the electrical harness assembly is formed by coupling multiple harness segments to one another, the costs associated with designing and manufacturing/forming electrical harnesses for a variety of row unit configurations (e.g., number of row units, spacing between row units, arrangement of row units, etc.) may be substantially reduced, as compared to designing and manufacturing a unique electrical harness for each row unit configuration (e.g., for each implement, for each toolbar, etc.). In addition, because the electrical harness assembly is formed by coupling multiple harness segments to one another, any harness segment within the electrical harness assembly may be replaced (e.g., due to wear of the harness segment), thereby substantially reducing maintenance costs (e.g., as compared to replacing an entire electrical harness assembly).

In the illustrated embodiment, each harness segment 66 does not include a harness controller. In addition, a controller is not communicatively coupled between any pair of harness segments. Accordingly, signals/electrical power may pass through the electrical harness assembly between a controller/electrical power source of the agricultural implement and the row unit components.

While the electrical harness assembly is disclosed herein with regard to a planting implement, the electrical harness assembly having multiple connectable harness segments may be utilized within other suitable agricultural implements. For example, in certain embodiments, an electrical harness assembly having multiple harness segments may be coupled to row unit components of a seeding implement, a tillage implement, a spraying implement, or any other suitable type of agricultural implement. In such embodiments, the electrical harness assembly may be readily formed for the implement configuration (e.g., number of row units, spacing between row units, arrangement of row units, etc.).

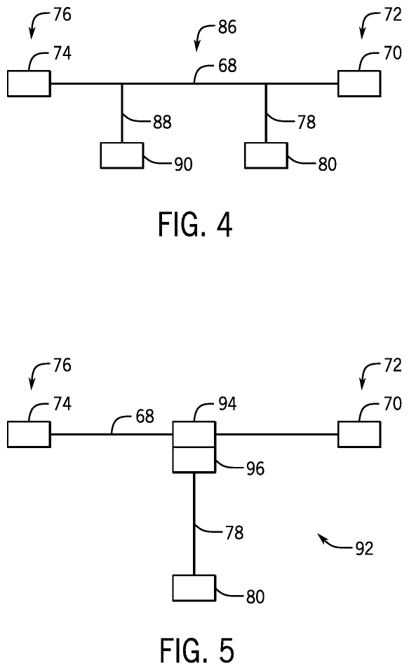

FIG. 4 is a schematic view of an embodiment of a harness segment 86 that may be employed within the electrical harness assembly of FIG. 3. In the illustrated embodiment, the harness segment 86 includes a first conductor assembly 68 and a first connector 70 coupled to a first end 72 of the first conductor assembly 68. In addition, the harness segment 86 includes a second connector 74 coupled to a second end 76 of the first conductor assembly 68. The second connector 74 of the harness segment 86 is configured to directly couple to the first connector 70 of a subsequent harness segment. Furthermore, the harness segment 86 includes a second conductor assembly 78 coupled to the first conductor assembly 68 between the first connector 70 and the second connector 74 (e.g., inclusive of the first connector 70 and the second connector 74). The harness segment 86 also includes a third connector 80 coupled to the second conductor assembly 78, in which the third connector 80 is configured to couple to at least one respective row unit component.

In the illustrated embodiment, the harness segment 86 includes a third conductor assembly 88 coupled to the first conductor assembly 68 between the first connector 70 an the second connector 74 (e.g., inclusive of the first connector 70 and the second connector 74). The harness segment 86 also includes a fourth connector 90 coupled to the third conductor assembly 88, in which the fourth connector 90 is configured to couple to at least one second respective row unit component. In certain embodiments, the second respective row unit component is on the same row unit as the first respective row unit component, which is coupled to the third connector. Furthermore, in certain embodiments, the second respective row unit component is on a different row unit than the first respective row unit component, which is coupled to the third connector. While the harness segment 86 includes two conductor assemblies coupled to the first conductor assembly 68 in the illustrated embodiment, in other embodiments, the harness segment may include more conductor assemblies (e.g., 3, 4, 5, 6, or more) coupled to the first conductor assembly and a corresponding number of respective connectors.

FIG. 5 is a schematic view of another embodiment of a harness segment 92 that may be employed within the electrical harness assembly of FIG. 3. In the illustrated embodiment, the harness segment 92 includes a first conductor assembly 68 and a first connector 70 coupled to a first end 72 of the first conductor assembly 68. In addition, the harness segment 92 includes a second connector 74 coupled to a second end 76 of the first conductor assembly 68. The second connector 74 of the harness segment 92 is configured to directly couple to the first connector 70 of a subsequent harness segment. Furthermore, the harness segment 92 includes a second conductor assembly 78 coupled to the first conductor assembly 68 between the first connector 70 and the second connector 74 (e.g., inclusive of the first connector 70 and the second connector 74). The harness segment 92 also includes a third connector 80 coupled to the second conductor assembly 78, in which the third connector 80 is configured to couple to a respective row unit component.

In the illustrated embodiment, the harness segment 92 includes a fourth connector 94 disposed along the first conductor 68 assembly between the first connector 70 and the second connector 74 (e.g., inclusive of the first connector 70 and the second connector 74). In addition, the harness segment 92 includes a fifth connector 96 coupled to the second conductor assembly 78 at an opposite end of the second conductor assembly 78 from the third connector 80. The fifth connector 96 is directly coupled to the fourth connector 94 to removably couple the second conductor assembly 78 to the first conductor assembly 68. Because the second conductor assembly 78 is separable from the first conductor assembly 68, the harness segment 92 may be readily adjusted for different implement configurations by selecting a second conductor assembly suitable for the row unit/row unit component arrangement. While the harness segment 92 includes a single removable conductor assembly/connector in the illustrated embodiment, in other embodiments, the harness segment may include multiple removable conductor assemblies/connectors (e.g., selectively removable from the first conductor assembly), and/or the harness segment may include one or more non-removable conductor assemblies/connectors (e.g., non-removable from the first conductor assembly). The electrical harness assembly may include any suitable number and any suitable type(s) of harness segments. For example, the electrical harness assembly may include one or more harness segments of the type(s) disclosed above with reference to FIG. 3, one or more harness segments of the type(s) disclosed above with reference to FIG. 4, one or more harness segments of the type(s) disclosed above with reference to FIG. 5, or a combination thereof.

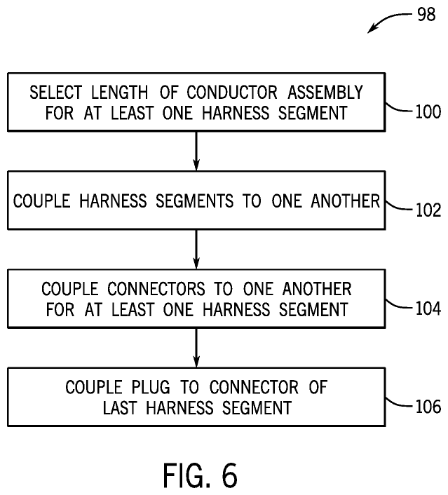

FIG. 6 is a flow diagram of an embodiment of a method 98 of forming an electrical harness assembly for an agricultural implement. In certain embodiments, a length of the first conductor assembly of at least one harness segment is selected based on a spacing between row units of the agricultural implement, as represented by block 100. As previously discussed, in certain agricultural implement configurations, the row units may be spaced apart from one another to establish 20-inch or 22-inch row spacing. For such implement configurations, the length of the first conductor assembly of each harness segment may be selected such that the third connector of each harness segment substantially aligns with corresponding connector(s) of the respective row unit component(s). Furthermore, in certain agricultural implement configurations, the row units may be spaced apart from one another to establish 36-inch or 40-inch row spacing. For such implement configurations, the length of the first conductor assembly of each harness segment may be selected such that the third connector of each harness segment substantially aligns with corresponding connector(s) of the respective row unit component(s).

Next, as represented by block 102, multiple harness segments are coupled to one another to form the electrical harness assembly. As previously discussed, coupling the harness segments to one another includes coupling the second connector of at least one harness segment directly to the first connector of a subsequent harness segment. In certain embodiments, at least one harness segment includes a fourth connector and a fifth connector, the fourth connector is disposed along the first conductor assembly between the first connector and the second connector (e.g., inclusive of the first connector and the second connector), and the fifth connector is coupled to the third connector by the second conductor assembly. In such embodiments, the method 98 of forming the electrical harness assembly includes coupling the fifth connector directly to the fourth connector for the at least one harness segment, as represented by block 104. In certain embodiments, a plug is coupled to the second connector of the last harness segment of the electrical harness assembly, as represented by block 106. As previously discussed, the plug is configured to substantially seal the second connector to substantially block dirt and/or debris from entering an interior of the second connector of the last harness segment. Furthermore, in certain embodiments (e.g., embodiments in which the electrical harness assembly is configured to facilitate passage of one or more communication signals), the plug may include circuitry configured to indicate to the implement controller that no additional row unit components are coupled to the electrical harness assembly (e.g., termination of a chain of row unit components). The steps of the method 98 may be performed in the order disclosed herein or in any other suitable order, and/or at least one of the steps of the method 98 may be omitted.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. An electrical harness assembly for an agricultural implement, comprising:
a plurality of harness segments coupled to one another, wherein each harness segment of the plurality of harness segments comprises a first connector, a second connector, and a third connector, the second connector of each harness segment of the plurality of harness segments is configured to directly couple to the first connector of a subsequent harness segment of the plurality of harness segments, the third connector of each harness segment of the plurality of harness segments is configured to couple to a respective row unit component, and each harness segment of the plurality of harness segments does not comprise a harness controller.

2. The electrical harness assembly of claim 1, comprising a plug configured to couple to the second connector of a last harness segment of the plurality of harness segments.

3. The electrical harness assembly of claim 1, wherein at least one harness segment of the plurality of harness segments comprises a fourth connector and a fifth connector, the fourth connector is disposed along a first conductor assembly between the first connector and the second connector, the fifth connector is coupled to the third connector by a second conductor assembly, and the fifth connector is configured to directly couple to the fourth connector.

4. The electrical harness assembly of claim 1, wherein the electrical harness assembly is configured to facilitate passage of one or more communication signals, the electrical harness assembly is configured to facilitate passage of electrical power, or a combination thereof.

5. The electrical harness assembly of claim 1, wherein at least one harness segment of the plurality of harness segments comprises a fourth connector configured to couple to a second respective row unit component.

6. The electrical harness assembly of claim 1, wherein a length of a conductor assembly extending between the first connector and the second connector of at least one harness segment of the plurality of harness segments is selected based on a spacing between row units of the agricultural implement.

7. An electrical harness assembly for an agricultural implement, comprising:
one or more harness segments, wherein each harness segment of the one or more harness segments comprises:
a first conductor assembly;
a first connector coupled to a first end of the first conductor assembly;
a second connector coupled to a second end of the first conductor assembly, wherein the second connector is configured to directly couple to the first connector of a subsequent harness segment;
a second conductor assembly coupled to the first conductor assembly between the first connector and the second connector; and
a third connector coupled to the second conductor assembly, wherein the third connector is configured to couple to a respective row unit component;
wherein each harness segment of the one or more harness segments does not comprise a harness controller.

8. The electrical harness assembly of claim 7, wherein the one or more harness segments comprises a plurality of harness segments coupled to one another.

9. The electrical harness assembly of claim 8, comprising a plug configured to couple to the second connector of a last harness segment of the plurality of harness segments.

10. The electrical harness assembly of claim 7, wherein the first conductor assembly and the second conductor assembly are configured to facilitate passage of one or more communication signals, to facilitate passage of electrical power, or a combination thereof.

11. The electrical harness assembly of claim 7, wherein at least one harness segment of the one or more harness segments comprises:
a third conductor assembly coupled to the first conductor assembly between the first connector and the second connector; and
a fourth connector coupled to the third conductor assembly, wherein the fourth connector is configured to couple to a second respective row unit component.

12. The electrical harness assembly of claim 7, wherein at least one harness segment of the one or more harness segments comprises:
a fourth connector disposed along the first conductor assembly between the first connector and the second connector; and
a fifth connector coupled to the second conductor assembly at an opposite end of the second conductor assembly from the third connector, wherein the fifth connector is directly coupled to the fourth connector to removably couple the second conductor assembly to the first conductor assembly.

13. The electrical harness assembly of claim 7, wherein a length of the first conductor assembly of at least one harness segment of the one or more harness segments is selected based on a spacing between row units of the agricultural implement.

14. A method of forming an electrical harness assembly for an agricultural implement, comprising:
coupling a plurality of harness segments to one another, wherein each harness segment of the plurality of harness segments comprises a first connector, a second connector, and a third connector, the third connector of each harness segment of the plurality of harness segments is configured to couple to a respective row unit component, and each harness segment of the plurality of harness segments does not comprise a harness controller;
wherein coupling the plurality of harness segments to one another comprises coupling the second connector of at least one harness segment of the plurality of harness segments directly to the first connector of a subsequent harness segment of the plurality of harness segments.

15. The method of claim 14, comprising coupling a plug to the second connector of a last harness segment of the plurality of harness segments.

16. The method of claim 14, comprising selecting, for at least one harness segment of the plurality of harness segments, a length of a conductor assembly extending between the first connector and the second connector based on a spacing between row units of the agricultural implement.

17. The method of claim 14, wherein at least one harness segment of the plurality of harness segments comprises a fourth connector and a fifth connector, the fourth connector is disposed along a first conductor assembly between the first connector and the second connector, and the fifth connector is coupled to the third connector by a second conductor assembly.

18. The method of claim 17, comprising coupling the fifth connector directly to the fourth connector for the at least one harness segment.

19. The method of claim 14, wherein the electrical harness assembly is configured to facilitate passage of one or more communication signals, the electrical harness assembly is configured to facilitate passage of electrical power, or a combination thereof.

20. The method of claim 14, wherein at least one harness segment of the plurality of harness segments comprises a fourth connector configured to couple to a second respective row unit component.
